(19) United States
(12) Patent Application Publication
(10) Pub. No.: US 2021/0168307 A1
(43) Pub. Date: Jun. 3, 2021

(54) IMAGE PROCESSING SYSTEM AND METHOD

(71) Applicant: SZ DJI TECHNOLOGY CO., LTD., Shenzhen (CN)

(72) Inventors: Junping MA, Shenzhen (CN); Qingtao ZHANG, Shenzhen (CN); Yueshan LIN, Shenzhen (CN)

(21) Appl. No.: 17/174,616

(22) Filed: Feb. 12, 2021

Related U.S. Application Data
(63) Continuation of application No. PCT/CN2018/103536, filed on Aug. 31, 2018.

(51) Int. Cl. H04N 5/33; H04N 5/232; B64C 39/02

(52) U.S. Cl. CPC H04N 5/332; H04N 5/23245; B64C 2201/127; B64C 39/024; B64C 2201/123; H04N 5/23232

(57) ABSTRACT

An image processing system includes an image sensor configured to obtain raw image data including first-type image data of a first type and second-type image data of a second type, an image data separation device configured to separate the first-type image data from the second-type image data, and an image processor configured to process the first-type image data and the second-type image data that are separated from each other.

### CROSS-REFERENCE TO RELATED APPLICATION

This application is a continuation of International Application No. PCT/CN2018/103536, filed Aug. 31, 2018, the entire content of which is incorporated herein by reference.

### TECHNICAL FIELD

The present disclosure relates to the field of image processing and, in particularly, to an image processing system and a corresponding method.

### BACKGROUND

Various image sensors are used to capture images. For example, an infrared image sensor detects objects that dissipate heat in the environment (such as animals in the wild environment or people), and performs thermal imaging to capture infrared images. Because the infrared image sensor images according to the amount of heat dissipated by the objects in the environment, the position of the objects in the environment is hard to be determined only according to the image captured by the infrared image sensor.

One solution is to use separate visible light image sensor and infrared image sensor, and to merge the visible light image and the infrared image obtained by the two sensors to determine the position of the object. For example, a dual image sensor solution may be used. That is, two image sensors, an infrared image sensor and a visible light image sensor, output images at the same time, and then the two images are merged with each other.

However, because the two images are obtained by two image sensors separately, the resolutions, imaging angles of view, imaging angles, and other parameters of the two images may be different, and hence it is hard to coincide the two images completely when they are merged.

### SUMMARY

In accordance with the disclosure, there is provided an image processing system including an image sensor configured to obtain raw image data including first-type image data of a first type and second-type image data of a second type, an image data separation device configured to separate the first-type image data from the second-type image data, and an image processor configured to process the first-type image data and the second-type image data that are separated from each other.

Also in accordance with the disclosure, there is provided an image processing method including obtaining raw image data including first-type image data of a first type and second-type image data of a second type, separating the first-type image data from the second-type image data, and processing the first-type image data and the second-type image data that are separated from each other.

Also in accordance with the disclosure, there is provided an unmanned aerial vehicle including one or more propulsion devices, a communication system configured to provide communication between the unmanned aerial vehicle and an external terminal, and an image processing system. The image processing system includes an image sensor configured to obtain raw image data including first-type image data of a first type and second-type image data of a second type, an image data separation device configured to separate the first-type image data from the second-type image data, and an image processor configured to process the first-type image data and the second-type image data that are separated from each other.

### BRIEF DESCRIPTION OF THE DRAWINGS

FIG. 1 is a block diagram of an image processing system consistent with embodiments of the disclosure.

FIG. 2A to FIG. 2D are schematic diagrams showing image data processing consistent with embodiments of the disclosure.

FIG. 3 is a schematic flowchart of an image processing method consistent with embodiments of the disclosure.

FIG. 4 is a block diagram of an unmanned aerial vehicle consistent with embodiments of the disclosure.

FIG. 5 is a schematic diagram of a computer-readable storage medium consistent with embodiments of the disclosure.

### DETAILED DESCRIPTION OF THE EMBODIMENTS

Technical solutions in the embodiments of the present disclosure will be described clearly and completely in detail with reference to the drawings below. It will be appreciated that the described embodiments are some rather than all of the embodiments of the present disclosure. Other embodiments conceived by those having ordinary skills in the art on the basis of the described embodiments without inventive efforts should fall within the scope of the present disclosure.

Unless otherwise defined, all technical and scientific terms used herein have the same or similar meanings as generally understood by one of ordinary skill in the art. As described herein, the terms used in the specification of the present disclosure are intended to describe example embodiments, instead of limiting the present disclosure. The term “and/or” used herein includes any suitable combination of one or more related items listed.

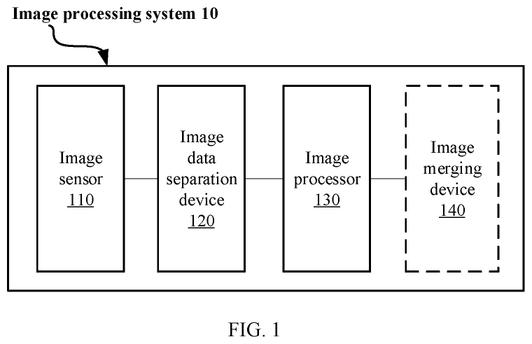

FIG. 1 is a block diagram of an image processing system consistent with embodiments of the disclosure. As shown in FIG. 1, the image processing system 10 includes an image sensor 110, an image data separation device 120, and an image processor 130. In some embodiments, the image processing system 10 further includes an image merging device 140 (shown as a dashed box).

The image sensor 110 is configured to simultaneously obtain image data including at least image data of a first type and image data of a second type. The image data of the first type is also referred to as “first-type image data” and the image data of the second type is also referred to as “second-type image data.” The image data obtained by the image sensor 110 that includes the at least image data of the first type and the image data of the second type is also referred to as “raw image data.” That is, the image sensor 110 may obtain two or more types of image data. The principle of the present disclosure is explained in detail by taking the image sensor 110 obtaining infrared images and visible light images as an example. For example, the image data of the first type may include infrared image data, and the image data of the second type may include visible light image data. However, those skilled in the art may understand that the image sensor 110 may also obtain other type and/or more types of image data, such as ultraviolet light image data.

In some embodiments, the image sensor 110 has alternately distributed infrared pixels and visible light pixels, and hence can simultaneously detect visible light and infrared light. In addition, the image sensor 110 may simultaneously output an infrared image and a visible light image, to achieve completely coincide of the infrared image and the visible light image.

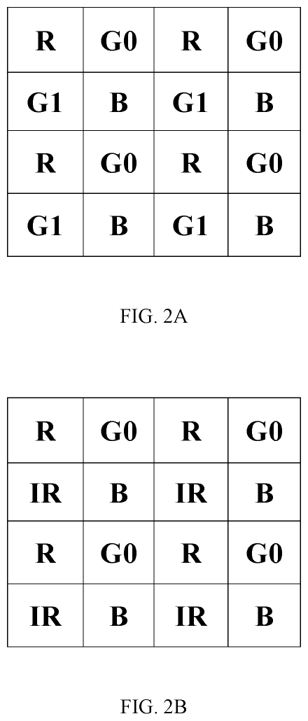

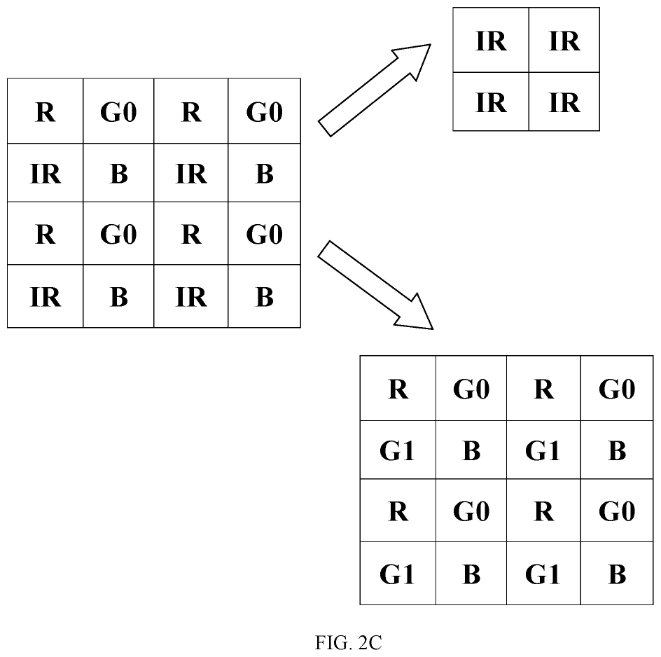

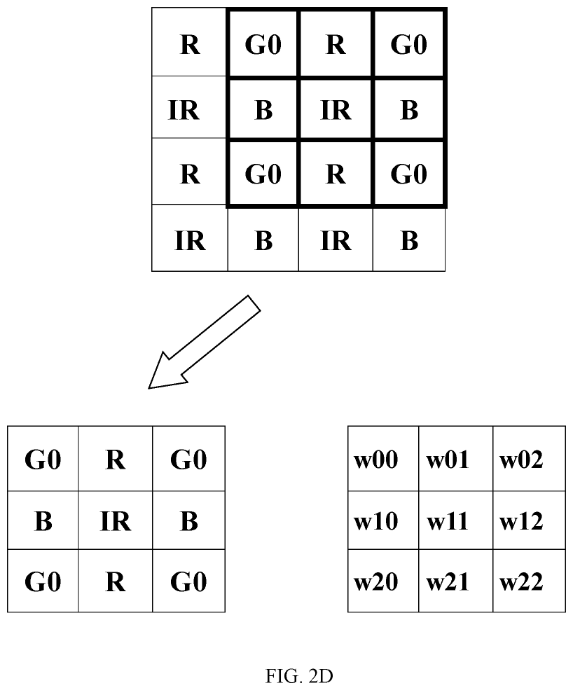

FIG. 2A is a schematic diagram of a CMOS image sensor. As shown in FIG. 2A, the CMOS image sensor includes a pixel array. Because of the photosensitive characteristics of CMOS devices, the pixel array is generally arranged in Bayer format, that is, each pixel includes one of three color components of R, G, and B, and the R, G, and B pixels are arranged in a certain pattern. A pattern of R, G, and B pixels is shown in FIG. 2A. In some embodiments, a Bayer image may be divided into 2×2 Bayer units, and each Bayer unit contains four components (an R component, a B component, and two G components (G0 and G1)).

Infrared photosensitive pixels need to be added to capture infrared images. FIG. 2B is a schematic diagram of an improved CMOS image sensor consistent with embodiments of the disclosure, which may be used as the image sensor 110 in FIG. 1. As compared to the CMOS sensor shown in FIG. 2A, in the improved CMOS image sensor shown in FIG. 2B, a G component (G1) is replaced with an infrared component IR. That is, as shown in FIG. 2B, each Bayer unit contains an R component, a B component, a G component (G0), and an IR component.

The pattern of infrared and visible light pixels in the image sensor is not limited to the examples shown in FIG. 2A and FIG. 2B. In addition, although the G component G1 is changed to the infrared component IR in FIG. 2B, those skilled in the art would understand that it is also conceivable to retain the G1 component and replace the G0 component, the B component, or the R component with the infrared component IR, to obtain an image sensor with both infrared pixels and visible light pixels.

As shown in FIG. 2B, infrared pixels and visible light pixels are alternately distributed in an image sensor 110 with both infrared pixels and visible light pixels. Therefore, signals from infrared pixels and visible light pixels are output alternately when an image is being output. Because of this characteristic of the image sensor 110, the data format of the output image is different from that of an ordinary CMOS, and may not be directly input into a usual image processor. Further, even if the image output by the image sensor 110 is directly input into an image processor, the image processor cannot process the infrared image data and the visible light image data because the infrared image data and the visible light image data are mixed together.

The two types of image data need to be separated before being input into an image processor for processing. In some embodiments, the image data separation device 120 may be configured to separate at least the image data of the first type and the image data of the second type output by the image sensor 110, to obtain at least the image data of the first type and the image data of the second type that are separated from each other. In some embodiments with an infrared image and a visible light image, the image data separation device 120 separates the infrared image data and the visible light image data output by the image sensor 110 to generate separated infrared image and visible light image, and then inputs the separated infrared images and visible light images into the image processor 130.

The image processor 130 is configured to process the at least the image data the first type and the image data of the second type separated by the image data separation device 120. In some embodiments with an infrared image and a visible light image, the image processor 130 may include separate infrared image processor and visible light image processor, to process the infrared image and the visible light image separately. That is, the infrared image processor may be configured to process the infrared image data output by the image data separation device 120, and the visible light image processor may be configured to process the visible light image data output by the image data separation device 120.

In some embodiments, the image data separation device 120 can include a Field Programmable Gate Array (FPGA). Because of the programmable characteristics of FPGA, the interface connection between the image data separation device 120 and various image sensors 130, and the interface connection between the image data separation device 120 and the image sensor 110 may be implemented conveniently.

The image data separation device 120 receives image data output by the image sensor 110, and separates infrared image data and visible light image data according to an image format. That is, the image data separation device 120 may be configured to obtain first infrared image data from the infrared image data and the visible light image data output by the image sensor 110. The first infrared image data can refer to infrared image data at one or more IR pixels obtained directly from the infrared image data and the visible light image data output by the image sensor 110. For example, as shown in FIG. 2C, to obtain an infrared image, the IR component (first infrared image data, e.g., the 2×2 infrared image data shown on the upper right side of the FIG. 2C) may be obtained directly from the infrared image data and the visible light image data obtained by the image sensor 110, and then may be arranged in a pattern to generate an infrared image.

To obtain a visible light image, the image data separation device 120 may be configured to obtain first visible light image data from the infrared image data and the visible light image data obtained by the image sensor 110. Then, second visible light image data for a position occupied by the infrared image data in the image sensor 110 is obtained according to the first visible light image data. That is, the second visible light image data can be visible light image data corresponding to one or more infrared pixel. Next, the visible light image data at the position occupied by the infrared image data is computed to obtain third visible light image data according to the first visible light image data and the second visible light image data.

For example, the image data separation device 120 obtains the first visible light image data (R component, G0 component, and B component in the original image data) from the image sensor 110, and restores the G1 component (the second visible light image data) at a position occupied by the IR component. The upper left, lower left, upper right, and lower right of the IR component are four G0 components, respectively. Therefore, in some embodiments, the image data separation device 120 may use the average value of these four G0 components as a G1 component (the third visible light image data) at the IR position. For example, restored visible light image data (including the R, G0, and B components in the original image data and the G1 component restored at the position occupied by the IR) is shown in the lower right side of FIG. 2C.

In fact, when the pixel array in an image sensor is exposed to light, adjacent pixels may affect each other, and the IR component may be affected by the surrounding R component, G component, and B component. In some embodiments, filter template may be used to restore an IR component, thereby more accurately obtaining an IR component. Therefore, the image data separation device 120 may be configured to obtain the first infrared image data (at one or more infrared pixels) and visible light image data surrounding the first infrared image data (surrounding visible light image data at one or more visible light pixels surrounding the one or more infrared pixels) from the infrared image data and the visible light image data obtained by the image sensor 110, and then obtain second infrared image data by correcting the first infrared image data and the visible light image data surrounding the first infrared image data. In some embodiments, the first infrared image data and the visible light image data surrounding the first infrared image data may be corrected by weighted average to obtain the second infrared image data.

FIG. 2D is a schematic diagram showing using filter template to restore the IR component. As shown in FIG. 2D, a 3×3 image area centered on the IR component (shown on the lower left side of FIG. 2D) is obtained from the original image data (shown in the upper part of FIG. 2D). In some embodiments, a 3×3 filter template is configured. In the 3×3 filter template, there are 9 coefficients (w00 . . . w22) with fixed values (shown on the lower right side of FIG. 2D). A weighted average of the values of the 9 pixels in the 3×3 image area is calculated using the 9 coefficients in the filter template and is used as a value of an IR component. For example, formula (1) below may be used to calculate the value of the IR component:

$$I R = \frac{G {0}^{*} w 00 + {R}^{*} w 0 \; 1 + ⋯ G {0}^{*} w 22}{w 00 + w01 + ⋯ w 22} \qquad ( 1 )$$

Similarly, when restoring visible light data, the image data separation device 120 may be configured to correct the second visible light image data to obtain the third visible light image data, and to obtain fourth visible light image data according to the first visible light image data and the third visible light image data. For example, the image data separation device 120 may compute a weighted average on the second visible light image data and the visible light image data surrounding the second visible light image data, and may correct the second visible light image data to obtain the third visible light image data. As shown in FIG. 2D, in some embodiments, an R component, a G0 component, and a B component in a visible light image (the first visible light image data) may be directly obtained. To restore the G1 component at the IR position, a 3×3 filter template may be configured with the G1 component as the center. A weighted average of the values of the 9 pixels in the 3×3 image area centered on the G1 component (the second visible light image data) may be calculated using the 9 coefficients in the filter template (for example, using the above formula (1) with different values of the coefficients w00 . . . w22), and used as a restored value of the G1 component (the third visible light image data). The restored G1 component value then may be combined with the R component, the G0 component, and the B component (the first visible light image data) directly obtained from the visible light image to obtain the final visible light image data (the fourth visible light image data).

Those skilled in the art may understand that a correction closer to the true value may be obtained by using different filter templates, such as 4×4, 5×5 or filter templates containing more components, or by setting appropriate filter template coefficients. Further, other suitable correction methods, such as bilateral filtering, gradient filtering, etc., may also be used for correction. The embodiments are only exemplary descriptions and are not limiting to the disclosure.

In some embodiments, the image data separation device 120 sends the separated infrared image and visible light image to the infrared image processor and the visible light image processor of the image processor 130, respectively. The infrared image processor and the visible light image processor execute the corresponding image processing algorithms after receiving the images. Then, the processed images are output separately.

Further, the image processing system 10 may be connected to a display device (not shown in FIG. 1), and the processed visible light image data and infrared image data are displayed on the display device. In addition, the resolution of the infrared image obtained by the image sensor 110 is smaller than that of the Bayer format image (in the above embodiment, the resolution of the infrared image is only a half of that of the Bayer image in both horizontal direction and height direction). The image data separation device 120 is also configured to sample infrared image data and/or visible light image data to realize a same resolution of the infrared image data as that of the visible light image data for better merging of the images. For example, the image data separation device 120 performs up-sampling on the infrared image data to obtain up-sampled infrared image data that has a same resolution as the visible light image data. In some embodiments, the image data separation device 120 performs down-sampling on the visible light image data to obtain down-sampled visible light image data that has a same resolution as the infrared image data.

In some embodiments, the image processor 130 performs up-sampling on the separated infrared image data, or down-sampling on the separated visible light image, instead of the image data separation device 120 performing up-sampling/down-sampling, to realize a same resolution of the infrared image data and of the visible light image data. That is, the image processor 130 performs up-sampling on the infrared image data, or down-sampling on the visible light image data to obtain a same resolution of the infrared image data and of the visible light image data.

In addition, the output processed images can be merged. For example, the image merging device 140 shown in FIG. 1 is used to implement image merging. In some embodiments, the image merging device 140 is a visible light image processor. The infrared image processor transmits the processed infrared image to the visible light image processor, and the visible light image processor (after processing visible light image data) merges the visible light image and the infrared image. In some embodiments, the infrared image processor is used as an image merging device and the visible light image is transmitted to the infrared image processor. In some embodiments, as shown in FIG. 1, a separate image merging device 140 is provided to receive the visible light image and the infrared image, and implement merging of the visible light image and the infrared image.

Further, the merged image can be directly output to the display device for displaying.

In the embodiments of the present disclosure, it is possible to achieve precise matching (the accuracy may reach the level of a single pixel) when the infrared image and the visible light image are merged. The infrared image is separated from the visible light image, and the separated images are respectively processed by the infrared image processor and the visible light image processor. As such, device selection for the system is more flexible.

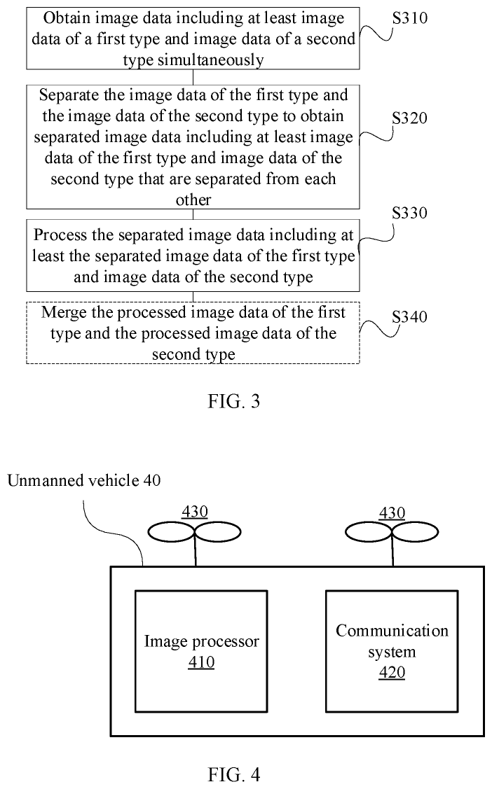

FIG. 3 is a schematic flowchart of an image processing method consistent with embodiments of the present disclosure.

At S310, image data including at least image data of a first type and image data of a second type are obtained simultaneously. For example, the image data of the first type includes infrared image data, and the image data of a second type includes visible light image data.

At S320, the image data including at least the image data of the first type and the image data of the second type is separated to obtain separated image data including at least image data of the first type and image data of the second type that are separated from each other. For example, the infrared image data and the visible light image data obtained at process S310 are separated from each other to obtain the separated infrared image data and visible light image data.

In some embodiments, first infrared image data at an infrared pixel is obtained from the obtained infrared image data and visible light image data. For example, to obtain an infrared image, the IR component (the first infrared image data) is directly obtained from a 2×2 Bayer unit, and then arranged in a pattern to generate an infrared image.

In some embodiments, first infrared image data at an infrared pixel and surrounding visible light image data at one or more visible light pixels surrounding the first infrared image data is obtained from the obtained infrared image data and visible light image data, and second infrared image data is obtained by correcting the first infrared image data and the surrounding visible light image data. For example, the first infrared image data and the surrounding visible light image data are corrected by weighted average to obtain the second infrared image data.

In some embodiments, to obtain the visible light image, the first visible light image data is obtained from the obtained infrared image data and visible light image data, and then the second visible light image data for the position occupied by infrared image data is obtained according to the first visible light image data. Next, the third visible light image data is obtained according to the first visible light image data and the second visible light image data obtained. The third visible light image data is obtained by correcting the second visible light image data. For example, the second visible light image data is corrected by weighted averaged of the second visible light image data and the pixel values surrounding the second visible light image data to obtain the third visible light image data. The fourth visible light image data is obtained according to the first visible light image data and the third visible light image data. Detailed description of the method is omitted, and reference can be made to the above description of the examples in connection with FIG. 2C and FIG. 2D.

At S330, the separated image data including at least the separated image data of the first type and image data of the second type is processed. For example, image data of the first type and/or image data of the second type may be sampled to realize a same resolution of the image data of the first type as that of the image data of the second type for a better image merging. For example, up-sampling may be performed on image data of the first type to obtain the image data of the first type after the up-sampling that has a same resolution as the image data of the second type. In some embodiments, down-sampling may be performed on image data of the second type to obtain the image data of the second type after down-sampling that has a same resolution as the image data of the first type.

In some embodiments, as shown in FIG. 3, the method further includes merging the processed image data of the first type and the processed image data of the second type to obtain merged image data for displaying (S340).

FIG. 4 is a block diagram of an unmanned aerial vehicle consistent with embodiments of the disclosure. As shown in FIG. 4, the unmanned aerial vehicle 40 includes an image processing system 410, such as the image processing system 10 described with reference to FIG. 1. The unmanned 40 also includes a communication system 420 and a propulsion device 430.

The communication system 420 may support a communication between an external terminal and the image processing system 410 via wireless signals. The communication system 420 may include any number of transmitters, receivers, and/or transceivers suitable for wireless communication. The communication may be one-way communication to allow data being transmitted in one direction only. For example, one-way communication may only involve the unmanned aerial vehicle 40 sending data to the external terminal. Data may be transmitted from one or more transmitters of the communication system 420 to one or more receivers of the external terminal, or vice versa. In some embodiments, the communication may be two-way communication to allow data being sent in both directions between the unmanned aerial vehicle 40 and the external terminal. Two-way communication may involve sending data from one or more transmitters of the communication system 40 to one or more receivers of the external terminal, and vice versa. For example, in some embodiments, the unmanned aerial vehicle 40 may send image data of the first type and image data of the second type processed by the image processing system 410 to the external terminal via the communication system 420.

The propulsion device 430 may include any number of rotors (e.g., one, two, three, four, five, six, or more). In the example shown in FIG. 4, the propulsion device 430 includes two rotors. The rotor may enable the unmanned aerial vehicle 40 to hover/hold position, change orientation, and/or change position. For example, the unmanned aerial vehicle 40 may have a horizontally oriented rotor, which may provide lift and/or thrust to the unmanned aerial vehicle 40. A plurality of horizontally oriented rotors may be driven to enable the unmanned aerial vehicle 40 to take off vertically, to land vertically, and to hover. In some embodiments, one or more of the horizontally facing rotors may rotate in a clockwise direction, and one or more of the horizontal rotors may rotate in a counterclockwise direction. For example, the quantity of clockwise rotors may be equal to the quantity of counterclockwise rotors. The rotation speed of the rotor in each horizontal orientation may be changed independently to control the lift and/or thrust generated by each rotor, thereby adjusting the spatial arrangement, speed and/or acceleration of the unmanned aerial vehicle 40 (for example, relative to a maximum of three degrees of translation and three degrees of rotation).

The distance between the shafts of the opposed rotors may be any suitable length. For example, the length may be less than or equal to 2 m, or less than or equal to 5 m. In some embodiments, the length may be in a range of 40 cm to 7 m, or of 70 cm to 2 m, or of 5 cm to 5 m.

In addition, those skilled in the art would understand that the unmanned aerial vehicle 40 may have one or more, two or more, three or more, or four or more propulsion devices. All propulsion devices may be of the same type. In some embodiments, the one or more propulsion devices may be different types of propulsion devices, such as one or more of rotors, propellers, blades, engines, motors, wheels, shafts, magnets, and nozzles. The propulsion device may be installed on any suitable part of an unmanned aerial vehicle 40, such as on the top, bottom, front, rear, side, or any suitable combination.

In addition, it is intended that the above embodiments of the disclosure are applied to an unmanned aerial vehicle but are not limited to it. For example, in some embodiments, the image processing system may also be applied to other mobile platform such as an unmanned automobile, an unmanned ship, a robot, etc.

In addition, the embodiments of the present disclosure may be implemented in the form of a computer program product. For example, the computer program product may be a computer-readable storage medium. A computer program is stored on the computer-readable storage medium, and when the computer program is executed on a computing device, related operations may be performed to implement the above-mentioned technical solutions consistent with the embodiments of the present disclosure.

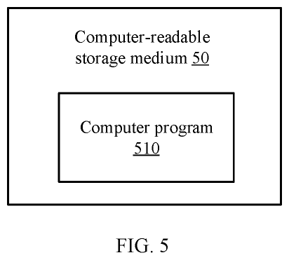

For example, FIG. 5 is a schematic diagram of a computer-readable storage medium consistent with embodiments of the disclosure. As shown in FIG. 5, the computer-readable storage medium 50 includes a computer program 510. When the computer program 510 is run by at least one processor, the at least one processor executes a method consistent with the disclosure, such as the example method described above in connection with FIG. 3.

Those skilled in the art would understand that the computer-readable storage medium 50 includes but is not limited to a semiconductor storage medium, an optical storage medium, a magnetic storage medium, or any other form of computer-readable storage medium.

The method and related devices consistent with embodiments of the present disclosure have been described above. Those skilled in the art would understand that the method described above is only exemplary. Methods consistent with the embodiments of the present disclosure are not limited to the processes and sequence shown above. For example, the above processes may be executed according to different orders in embodiments of the present disclosure, or executed in parallel.

It should be understood that the embodiments of the present disclosure may be implemented in software, hardware, or a combination of both software and hardware. For example, the embodiments of the present disclosure may be implemented by a software, a program and/or other data structures set or encoded on a computer-readable medium such as an optical medium (e.g., CD-ROM), a floppy disk, or a hard disk, or by a firmware or other medium of microcode on one or more ROM, or RAM, or a PROM chip, or a downloadable software image, or shared database in one or more modules, etc. The software or firmware or such a configuration may be installed on a computing device, to enable one or more processors in the computing device to execute the technical solutions described in the embodiments of the present disclosure.

In addition, each functional module or each feature of the device used in each of the embodiments may be implemented or executed by a circuit, which is usually one or more integrated circuits. The circuit designed to perform the functions described in the embodiments of the present disclosure may include a general-purpose processor, a digital signal processor (DSP), an application-specific integrated circuit (ASIC), or a general-purpose integrated circuit, a field programmable gate array (FPGA), or other programmable logic device, discrete gate or transistor logic, or a discrete hardware component, or any combination of the above devices. The general-purpose processor may be a microprocessor, or the processor may be an existing processor, a controller, a microcontroller, or a state machine. The above-mentioned general-purpose processor or each circuit may be configured by a digital circuit, or by a logic circuit. In addition, when an advanced technology that may replace current integrated circuit appears because of the improvement in semiconductor technology, the embodiments of the present disclosure may also use the integrated circuit obtained by the advanced technology.

The program running on the device consistent with the embodiment of the present disclosure may be a program that enables the computer to implement the function consistent with the embodiment of the present disclosure by controlling a central processing unit (CPU). The program or the information processed by the program may be temporarily stored in a volatile memory (such as a random-access memory RAM), a hard disk drive (HDD), a non-volatile memory (such as a flash memory), or other memory systems. The program for implementing the function consistent with the embodiments of the present disclosure may be stored on a computer-readable storage medium. Corresponding functions may be implemented by causing the computer system to read the program stored on the storage medium and execute the program. The so-called “computer system” herein may be a computer system embedded in the device, and may include an operating system or a hardware (such as a peripheral device).

As above, the embodiments of the present disclosure have been described in detail with reference to the drawings. However, the specific structure is not limited to the above embodiments, and the embodiments of the present disclosure also include any design changes that do not deviate from the spirit of the embodiments of the present disclosure. In addition, various modifications may be made to the description of the embodiments of the present disclosure within the scope of the disclosure, and embodiments obtained by appropriately combining the different technical solutions in the embodiments are also included in the technical scope of the embodiments of the present disclosure. In addition, the components having the same effects described in the above embodiments may be substituted for each other.

What is claimed is:

1. An image processing system comprising:
an image sensor configured to obtain raw image data including first-type image data of a first type and second-type image data of a second type;
an image data separation device configured to separate the first-type image data from the second-type image data; and
an image processor configured to process the first-type image data and the second-type image data that are separated from each other.

2. The image processing system of claim 1, wherein the first-type image data includes infrared image data, and the second-type image data includes visible light image data.

3. The image processing system of claim 2, wherein the image processor includes:
an infrared image processor configured to process the infrared image data from the image data separation device to obtain processed infrared image data; and
a visible light image processor configured to process the visible light image data from the image data separation device to obtain processed visible light image data.

4. The image processing system of claim 3, wherein:
the infrared image processor is further configured to send the processed infrared image data to the visible light image processor;
the visible light image processor is further configured to merge the processed visible light image data and the processed infrared image data from the infrared image processor to obtain merged image data; and
the merged image data is displayed on a display device connected to the image processing system.

5. The image processing system of claim 2, wherein the image data separation device is configured to obtain infrared image data at an infrared pixel from the raw image data.

6. The image processing system of claim 2, wherein the image data separation device is configured to:
obtain first infrared image data at an infrared pixel and surrounding visible light image data at one or more visible light pixels surrounding the infrared pixel from the raw image; and
perform correction on the first infrared image data and the surrounding visible light image data to obtain second infrared image data.

7. The image processing system of claim 5, wherein:
performing correction on the first infrared image data and the surrounding visible light image data includes calculating a weighted average of the first infrared image data and the surrounding visible light image data as the second infrared image data; and
the second infrared image data is displayed on a display device connected to the image processing system.

8. The image processing system of claim 2, wherein the image data separation device is further configured to:
obtain first visible light image data from the raw image data;
obtain second visible light image data for an infrared pixel of the image sensor according to the first visible light image data;
obtain third visible light image data by correcting the second visible light image data; and
obtain fourth visible light image data according to the first visible light image data and the third visible light image data.

9. The image processing system of claim 7, wherein
the image data separation device is further configured to obtain the third visible light image data by computing a weighted average of the second visible light image data and surrounding visible light image data at one or more visible light pixels surrounding the infrared pixel; and
the fourth visible light image data is displayed on a display device connected to the image processing system.

10. The image processing system of claim 1, wherein the image data separation device is further configured to:
perform up-sampling on the first-type image data to obtain up-sampled first-type image data that has a same resolution as the second-type image data; or
perform down-sampling on the second-type image data to obtain down-sampled second-type image data that has a same resolution as the first-type image data.

11. The image processing system of claim 1, wherein the image processor is further configured to:
perform up-sampling on the first-type image data to obtain up-sampled first-type image data that has a same resolution as the second-type image data; or
perform down-sampling on the second-type image data to obtain down-sampled second-type image data that has a same resolution as the first-type image data.

12. The image processing system of claim 1, further comprising:
an image merging device configured to merge the first-type image data and the second-type image data processed by the image processor to obtain merged image data.

13. The image processing system of claim 1, wherein the image data separation device includes a field programmable gate array.

14. An image processing method comprising:
obtaining raw image data including first-type image data of a first type and second-type image data of a second type;
separating the first-type image data from the second-type image data; and
processing the first-type image data and the second-type image data that are separated from each other.

15. The image processing method of claim 14, wherein the first-type image data includes infrared image data, and the second-type image data includes visible light image data.

16. The image processing method of claim 15, wherein separating the first-type image data from the second-type image data includes obtaining infrared image data at an infrared pixel from the raw image data.

17. The image processing method of claim 15, wherein separating the first-type image data from the second-type image data includes:
obtaining first infrared image data at an infrared pixel and surrounding visible light image data at one or more visible light pixels surrounding the first infrared image data from the raw image data; and
correcting the first infrared image data and the surrounding visible light image data to obtain second infrared image data.

18. The image processing method of claim 17, wherein correcting the first infrared image data and the surrounding visible light image data includes:
calculating a weighted average of the first infrared image data and the surrounding visible light image data as the second infrared image data.

19. The image processing method of claim 15, wherein separating the first-type image data from the second-type image data includes:
obtaining first visible light image data from the raw image data; and
obtaining second visible light image data for an infrared pixel of the image sensor according to the first visible light image data.

20. An unmanned aerial vehicle comprising:
one or more propulsion devices;
a communication system configured to provide communication between the unmanned aerial vehicle and an external terminal; and
an image processing system comprising:
an image sensor configured to obtain raw image data including first-type image data of a first type and second-type image data of a second type;
an image data separation device configured to separate the first-type image data from the second-type image data; and
an image processor configured to process the first-type image data and the second-type image data that are separated from each other.
